(19) United States
(12) Patent Application Publication
(10) Pub. No.: US 2023/0259475 A1
(43) Pub. Date: Aug. 17, 2023

(54) SYSTEM ON CHIP

(71) Applicant: Owen Yuwen Li, Vancouver, WA (US)

(72) Inventor: Owen Yuwen Li, Vancouver, WA (US)

(21) Appl. No.: 17/705,403

(22) Filed: Mar. 28, 2022

(30) Foreign Application Priority Data
Feb. 16, 2022 (TW) 111105654

(51) Int. Cl. G06F 13/40; G06F 13/16

(52) U.S. Cl. CPC G06F 13/4022; G06F 13/1668

(57) ABSTRACT

A system on chip comprises a memory block, a control block, a first logic block, a longitudinal/transverse crossbar switch, a bus direct memory access block, a second logic block and a global control block. The control block, the first logic block and the second logic block are electrically connected to the longitudinal/transverse crossbar switch. The first logic block is placed between the control block and the longitudinal/transverse crossbar switch, whereby the number of the circuit stages through which the data must be transmitted is reduced so as to achieve reduction of delay.

### This application claims the priority benefit of Taiwan patent application number 111105654 filed on Feb. 16, 2022.

### BACKGROUND OF THE INVENTION

### 1. Field of the Invention

The present invention relates generally to a computing system architecture, and more particularly to a system on chip.

### 2. Description of the Related Art

A common computing system architecture such as a unified memory access (UMA) architecture is characterized in that the external memory or memory set is commonly used and shared by multiple processors. The unified memory access (UMA) architecture is also referred to as unified addressing technique or unified memory access.

As shown in FIG. 1A, the UMA architecture generally controls a memory A2 via a controller A1. The controller A1 controls the access of the respective processors A4 to the memory A2 via an arbitration logic A3. The arbitration logic A3 usually includes some local embedded memory for temporary local storage. The embedded memory in the UMA architecture is generally a First in, First out (FIFO) cache. The arbitration logic A3 performs arbitration decisions (such as first of the queue is processed first). That is, the request access given higher priority (such as entering the queue earlier) will be processed first, while the requested access in lower priority (such as entering the queue later) must wait in sequence. Therefore, a great amount of loads need to be buffered. Such architecture will lead to delay in queuing, which ultimately increases access delay of the memory A2.

Conventionally, when employing UMA or the like technique, the memory can only provide a small bandwidth as limited by its IPs. (For example, the bandwidth of 16-channels of graphics double data rate, version 6 (GDDR6) is about 4Tb/s). Therefore, their bandwidth limits that of the entire system. In recent years, both memory and packaging technologies have seen rapidly advances, among which Through Silicon Via (TSV) stacked packaging technique is developed. Due to the Through Silicon Via (TSV) stacked packaging technique, the number of the memory blocks is significantly increased and the number of the memory interfaces is also increased with the memory blocks. Therefore, a great number of memory blocks can be mounted on the host chip so that the memory blocks are distributed over the full chip. The bandwidth of such hardware can reach the order of 4TB/s, (which is 8 times the bandwidth of the aforementioned example of 16-channels GDDR6). The conventional UMA or similar technique can hardly support such great bandwidth. Therefore, it has become a challenge how to overcome the bandwidth bottleneck and reduce associated delay.

Another system architecture is memory crossbar. Please refer to FIG. 1B. Multiple processing units B2 are positioned on one side of the longitudinal/transverse crossbar B1. The processing units B2 comprise logic blocks (such as processors, accelerators, etc.) Multiple memory units B3 are positioned on the other side of the longitudinal/transverse crossbar B1. The memory units B3 are memory devices and may include their controllers. The I/O connections of the memory units B3 send data through the longitudinal/transverse crossbar B1 to the logic blocks of the processing units B2 for processing. Then the results are sent through the longitudinal/transverse crossbar B1 back to the memory devices of the memory units B3 for storage.

According to the above, the data need to be processed by the logic blocks on one side of the longitudinal/transverse crossbar B1. Then the processed results are sent through the longitudinal/transverse crossbar B1 to the memory devices of the memory units B3 for storage. Therefore, the peak throughput of the longitudinal/transverse crossbar B1 will put a limit on actual usable amount of total bandwidth of the memory units B3. If the total bandwidth of the memory units B3 is relatively small, there will be no significant impact. However, if the total bandwidth of the memory units B3 is significantly increased through the new manufacturing process (such as the aforementioned TSV), the usable bandwidth of the crossbar will become the bottleneck. This is especially pronounced if some packet switching scheme is used to implement the crossbar.

In general, the memory units B3 are positioned on one or more of the edges of the main chip. Even if the new manufacturing process is employed, some of the memory units B3 are more distant from some logic blocks than others. Therefore, when it is desired to connect the far-away logic blocks with the memory units B3, the longer distance will lead to higher delay.

### SUMMARY OF THE INVENTION

It is a primary objective of the present invention to provide a system on chip architecture, which fully utilizes the memory bandwidth by reducing the required peak throughput of the longitudinal/transverse crossbar so as to remove the bottleneck of the accessible bandwidth of the memory blocks.

It is a further objective of the present invention to provide a system on chip architecture, which can reduce delay.

To achieve the above and other objectives, the system on chip of the present invention comprises multiple memory blocks, multiple memory control blocks, multiple first logic blocks, a longitudinal/transverse crossbar switch, a bus direct memory access (BUS DMA) block and multiple second logic blocks. The memory blocks and the memory control blocks are electrically connected to each other. The memory control blocks and the first logic blocks are electrically connected to each other. The first logic blocks are electrically connected to the longitudinal/transverse crossbar switch. The multiple memory blocks, the multiple memory control blocks and the multiple first logic blocks form a north section. The bus direct memory access block is electrically connected to the longitudinal/transverse crossbar switch. The second logic blocks are electrically connected to the longitudinal/transverse crossbar switch. The bus direct memory access block and the second logic blocks form a south section. The first logic blocks are intended to perform calculations which require larger bandwidth (such as from 4 to 8 TB/s). The second logic blocks are intended to perform calculations of smaller bandwidth (such as under 4 Tb/s).

The system on chip of the present invention further includes a global control block. One side of the global control block is electrically connected to the memory control blocks, the first logic blocks, the longitudinal/transverse crossbar switch, the bus direct memory access block and the second logic blocks. In addition, the global control block serves to receive/transmit control signals (such as reset signal RESET and clock signal CLK) to the above blocks. Moreover, the other side of the global control block and the bus direct memory access and the second logic blocks form a system bus.

By means of the change of the chip system architecture, a first logic block is positioned between the longitudinal/transverse crossbar switch and the multiple memory control blocks. The first logic blocks are intended to perform calculations of larger bandwidth (e.g. from 4 to 8 TB/s), whereby the number of the circuit stages in the first logic block is kept small so as to achieve reduction of delay. The second logic blocks are intended to perform calculation of smaller bandwidth (e.g. under 4 Tb/s). Accordingly, the computational functions of the entire system can be selectively distributed to the first logic blocks and the second logic blocks. Also, the first logic blocks and the second logic blocks are respectively placed in the north section and the south section on upper and lower sides of the longitudinal/transverse crossbar switch and have different processing abilities, whereby the upward and downward data transmission through the longitudinal/transverse crossbar switch can be reduced so as to achieve the effect of reduction of delay, as a significant number of data paths do not involve the crossbar switch. In addition, instead of implementing longitudinal/transverse crossbar switches in packet switching mode, the longitudinal/transverse crossbar switch of the present invention is in a circuit switching mode. By means of the circuit switching mode, the data transmission can be limited to a specific set of paths (such as lines on specific on-chip interconnect layers and switching circuits) so as to eliminate the delays caused by packet processing. Furthermore, the processing of the entire system is distributed between the first logic blocks and the second logic blocks so that the overall logical processing performance is improved.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein:

FIG. 1A is a schematic diagram of a conventional UMA architecture;

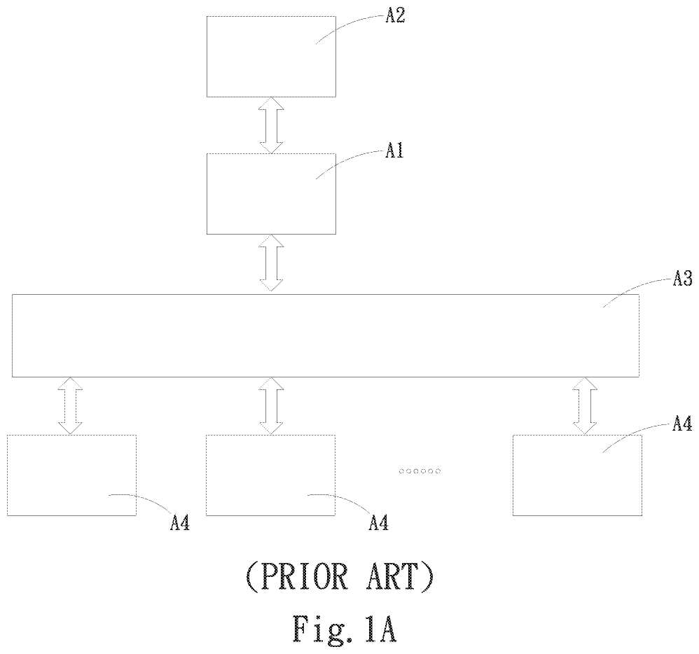

FIG. 1B is a schematic diagram of a memory crossbar architecture;

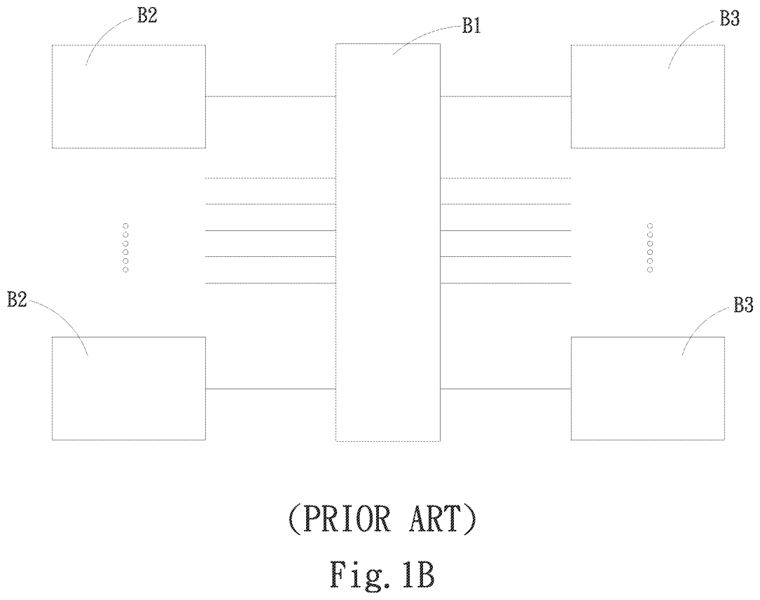

FIG. 2 is a schematic diagram of a first embodiment of the system on chip of the present invention;

FIG. 3 is a schematic diagram of a second embodiment of the system on chip of the present invention;

FIG. 4A is a schematic diagram of the longitudinal/transverse crossbar transmission path of the system on chip of the present invention; and

FIG. 4B is a schematic diagram of the longitudinal/transverse crossbar transmission path of the system on chip of the present invention in conjunction with optical transceivers.

### DETAILED DESCRIPTION OF THE PREFERRED EMBODIMENTS

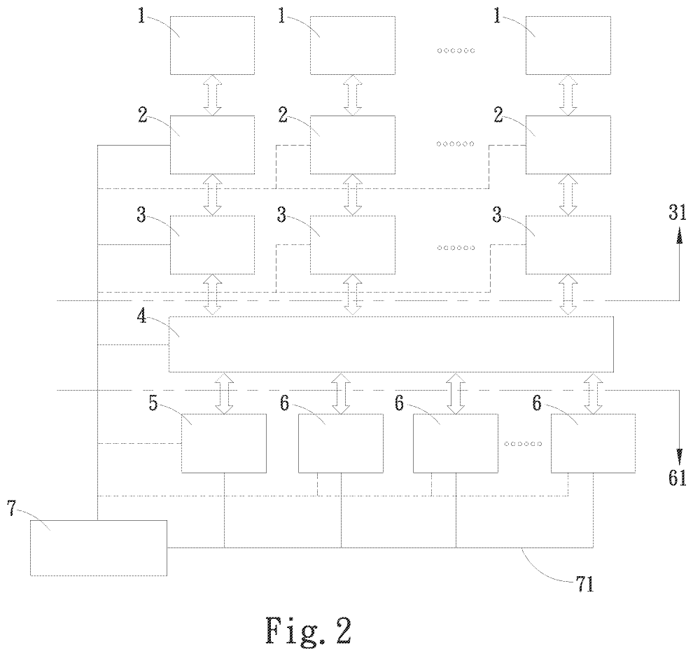

Please refer to FIG. 2, which is a schematic diagram of a first embodiment of the system on chip of the present invention. The system on chip of the present invention comprises multiple memory blocks 1, multiple memory control blocks 2, multiple first logic blocks 3, a longitudinal/transverse crossbar switch 4, a bus direct memory access block (BUS DMA) 5 and multiple second logic blocks 6. The memory blocks 1 and the memory control blocks 2 are electrically connected to each other. The memory control blocks 2 and the first logic blocks 3 are electrically connected to each other. The first logic blocks 3 are electrically connected to the longitudinal/transverse crossbar switch 4. The multiple memory blocks 1, the multiple memory control blocks 2 and the multiple first logic blocks 3 form a north section 31. The bus direct memory access block (BUS DMA) 5 is electrically connected to the longitudinal/transverse crossbar switch 4.

The second logic blocks 6 are electrically connected to the longitudinal/transverse crossbar switch 4. The bus direct memory access block 5 and the second logic blocks 6 form a south section 61. The first logic blocks 3 performs calculations of larger bandwidth (e.g. from 4 to 8 TB/s). The second logic blocks 6 performs calculations of smaller bandwidth (e.g. under 4 Tb/s).

The total bandwidth of the first logic blocks 3 must be larger than or equal to the total bandwidth of the memory blocks 1. If the memory blocks 1 comprise relatively simple memories (e.g. SRAM or pseudo-SRAM(PSRAM)) instead of typical DRAM, the memory control blocks 2 can be simple memory interfaces for transmitting and receiving control signals from/to the first logic blocks 3. The total bandwidth of the longitudinal/transverse crossbar switch 4 is smaller than or equal to the total bandwidth of the first logic blocks 3. The longitudinal/transverse crossbar switch 4 is implemented in a circuit switching mode, so that the end-to-end data path includes no more than simple circuit switches. The longitudinal/transverse crossbar switch 4 employs two interconnect layers (such as a longitudinally arranged interconnect layer and a transversely arranged interconnect layer). The two interconnect layers are longitudinally and transversely arranged to intersect each other and form multiple intersection points for providing data transmission and communication between the south section 61 and the north section 31. Circuit switches are placed near the crossing point of interconnect lines.

The system on chip of the present invention further comprises a global control block 7. One side of the global control block 7 is electrically connected to the memory control blocks 2, the first logic blocks 3, the longitudinal/transverse crossbar switch 4, the bus direct memory access block 5 and the second logic blocks 6. In addition, the global control block 7 serves to receive/transmit control signals (such as reset signal RESET and clock signal CLK) to the above blocks. Moreover, the other side of the global control block 7 and the bus direct memory access block and the second logic blocks 6 form a system bus 71.

By design of the system architecture, a first logic block 3 is placed between the longitudinal/transverse crossbar switch 4 and the multiple memory control blocks 2. The first logic blocks 3 performs calculations of larger bandwidth (e.g. from 4 to 8 Tb/s), whereby the number of the circuit stages through which the data must be exchanged between the first logic block 3 and the memory block 1 is reduced so as to achieve reduction of delay. The second logic blocks 6 perform calculations of smaller bandwidth (e.g. under 4 Tb/s). Accordingly, the calculation of the entire system can be selectively distributed to the first logic blocks 3 and the second logic blocks 6. Also, the first logic blocks 3 and the second logic blocks 6 are respectively placed in the north section 31 and the south section 61 on upper and lower sides of the longitudinal/transverse crossbar switch 4 and have different processing abilities, whereby the upward and downward data transmission through the longitudinal/transverse crossbar switch 4 can be reduced so as to achieve reduction of delay. In addition, instead of implementing the longitudinal/transverse crossbar switches 4 in a packet switching mode, the longitudinal/transverse crossbar switch 4 of the present invention is implemented in a circuit switching mode. By means of the circuit switching mode, the data transmission can be kept to a specific path (such as wires on specific interconnect layers) and through only simple circuit switches so as to reduce the delay caused by packet processing.

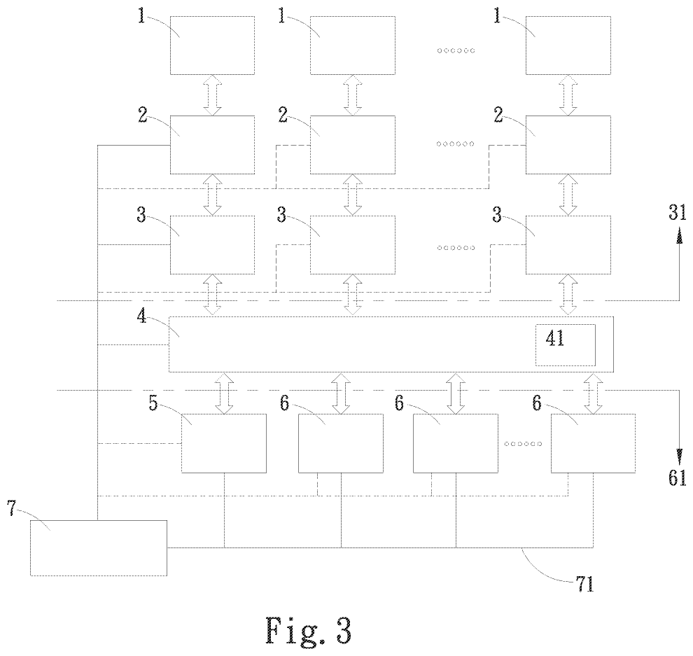

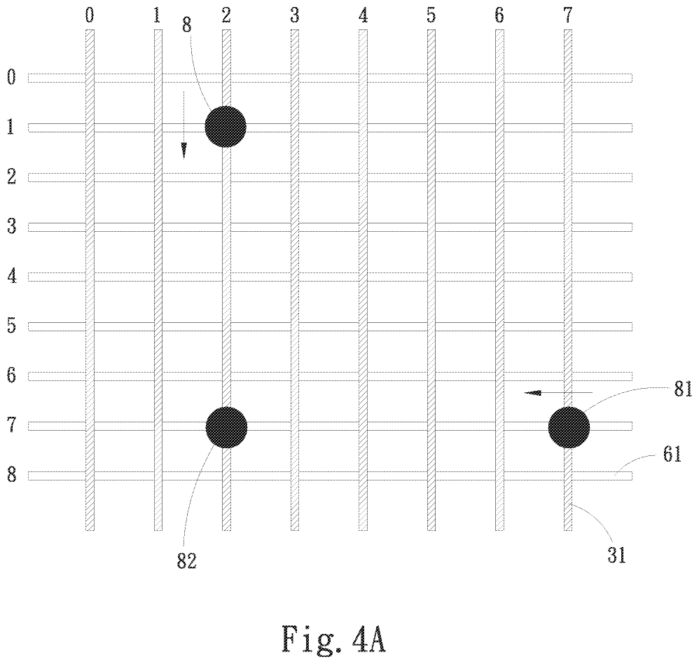

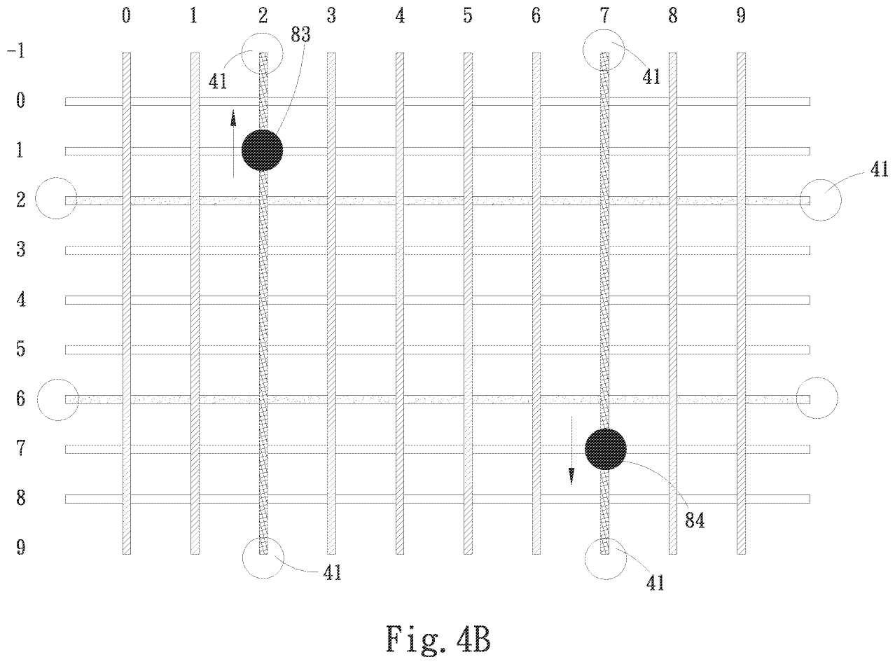

Please refer to FIGS. 3, 4A and 4B. FIG. 3 is a schematic diagram of a second embodiment of the system on chip of the present invention. FIG. 4A is a schematic diagram of the longitudinal/transverse crossbar transmission path of the system on chip of the present invention. FIG. 4B is a schematic diagram of the longitudinal/transverse crossbar transmission path of the system on chip of the present invention in cooperation with optical transceivers. The second embodiment is substantially similar to the first embodiment in structure, connection relationship and effect and thus will not be repeated hereinafter. The second embodiment is different from the first embodiment in that multiple optical transceivers 41 are placed in the longitudinal/transverse crossbar switch 4 of this second embodiment and optical strapping (with fiber) is formed between each two optical transceivers 41. Please refer to FIG. 4A, which shows that the interconnect layers longitudinally and transversely arranged in the longitudinal/transverse crossbar switch 4 are respectively connected to the north section 31 and the south section 61. For illustration purposes an A-point 8 and a B-point 81 are marked in FIG. 4A. One may assume coordinate of the A-point 8 is (2,1), while the coordinate of the B-point 81 is (7,7). When it is desired to establish connection between the A-point 8 and the B-point 81, the A-point 8 is vertically routed, while B-point 81 is horizontally routed to have an intersection point 82. We assume the delay time of each grid is about 1440 ps (picosecond) for illustration purposes only. This delay time is primarily the resistance-capacitance delay time (RC Delay) of metal wires. This delay time varies with different manufacturing processes. In this example, the A-point 8 is vertically routed through 6 grids and the B-point 81 is horizontally routed through 5 grids to obtain a total moving distance of 11 grids and the total delay time is 15.84 ns (nanosecond).

Please refer to FIG. 4B, which shows the longitudinally arranged interconnect layer of the north section 31 formed in the longitudinal/transverse crossbar switch 4 and the transversely arranged interconnect layer of the south section 61 formed in the longitudinal/transverse crossbar switch 4. An optical transceiver 41 is placed at each end of the interconnect wire(s). The longitudinally arranged interconnect layer and the transversely arranged interconnect layer intersect each other to form multiple intersection contact points as assumed coordinates. An optical transceiver 41 is placed at each end of the interconnect line. A C-point 83 and a D-point 84 are marked in FIG. 4B. The assumed coordinate of the C-point 83 is (2,1), while the assumed coordinate of the D-point 84 is (7,7). When it is desired to connect the C-point 83 and the D-point 84, the C-point 83 is perpendicularly routed to the optical transceiver 41 by 2 grids, while the D-point 84 is perpendicularly routed to the optical transceiver 41 by 2 grids. The delay time of each grid is about 1440 ps (picosecond). We assume in this example the delay time of the optical transceiver 41 is 1.5 ns. The optical transmission formed between the optical transceivers 41 has approximately zero delay. Therefore, the total routing distance for the connection of the C-point 83 and the D-point 84 through the optical transceivers 41 is 4 grids plus two optical transceivers 41 (one-time receiving and one-time transmission). Therefore, the total delay time is 10.2 ns.

TABLE 1
comparison table between delay time without optical transceivers
and delay time with optical transceivers

| | without optical | with optical |
|---|---|---|
| | transceivers | transceivers |
| delay time/grid | 1440 ps | 1440 ps |
| optical transceiver | (Not Used) | 1.5 ns |
| delay time | | |
| delay time from (2, 1) | 11 grids, need about | 4 grids and two optical |
| to (7, 7) | 15.84 ns | transceivers, need |
| | | about 8.76 ns |
| | | (Via optical |
| | | transceiver at |
| | | (2, −1) and (7, 9)) |
| delay time from (0, 0) | 15 grids, need about | 4 grids and two optical |
| to (7, 8) | 21.6 ns | transceivers, need |
| | | about 8.76 ns |
| | | (Via optical |
| | | transceiver at |
| | | (2, −1) and (7, 9)) |

It can be deduced from the above examples and table 1 that multiple optical transceivers 41 can be beneficially added to the longitudinal/transverse crossbar switch 4. Optical strapping is formed between the respective optical transceivers 41, whereby the resistance-capacitance delay time (RC Delay) for routing in the chip (such as metal connection wire) is reduced. Especially, the longer the interconnect delay, the more delay time is reduced by the present invention.

In a modified embodiment, the longitudinal/transverse crossbar switch 4 equipped with the optical transceivers 41 has multiple interconnect layers, (for example, two interconnect layers, one of which is longitudinally arranged, while the other of which is transversely arranged). If no optical transceivers are used, the longitudinal interconnect layer is used to route from the north section 31 to the longitudinal/transverse crossbar switch 4. The transverse interconnect layer is used to route from the south section 61 to the longitudinal/transverse crossbar switch 4. Alternatively, the longitudinal interconnect layer is used to route from the south section 61 to the longitudinal/transverse crossbar switch 4, while the transverse interconnect layer is used to route from the north section 31 to the longitudinal/transverse crossbar switch 4. Next we explain the use of the optical transceivers. Preferably, the optical transceivers 41 are placed at the ends of the respective interconnect wire(s). Alternatively, the longitudinal/transverse crossbar switch 4 has three interconnect layers, (for example, one interconnect layer is longitudinally arranged, while the other two interconnect layers are transversely arranged or two interconnect layers are longitudinally arranged, while the other interconnect layer is transversely arranged). One of the interconnect layers is used to connect to the optical transceivers 41, another of the interconnect layers is used to connect to the north section 31 and the south section 61, while the final one of the interconnect layers is commonly used to connect to the optical transceivers 41 and the north section 31 and the south section 61. Still alternatively, the longitudinal/transverse crossbar switch 4 has a fourth interconnect layer, (for example, two interconnect layers are longitudinally arranged, while the other two interconnect layers are transversely arranged). The two longitudinally arranged interconnect layers are connected to the north section 31, while the two transversely arranged interconnect layers are connected to the south section 61. Alternatively, the two longitudinally arranged interconnect layers are connected to the south section 61, while the two transversely arranged interconnect layers are connected to the north section 31. Preferably, one of the longitudinally arranged interconnect layers and one of the transversely arranged interconnect layers are specifically used to connect with the optical transceivers 41.

According to the above arrangement, the system on chip of the present invention provides a structure fully utilizing memory bandwidth so as to reduce the peak throughput requirement of the longitudinal/transverse crossbar, whereby the limit to the total usable bandwidth of the memory blocks due to the crossbar bandwidth is removed. Also, the number of the circuit blocks through which the data must be transmitted is reduced so as to improve the problem of delay of data transmission.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A system on chip comprising:
multiple memory blocks;
multiple memory control blocks;
multiple first logic blocks;
a longitudinal/transverse crossbar switch;
a bus direct memory access block;
multiple second logic blocks, the memory blocks and the memory control blocks being electrically connected to each other, the memory control blocks and the first logic blocks being electrically connected to each other, the first logic blocks being electrically connected to the longitudinal/transverse crossbar switch, the bus direct memory access being electrically connected to the longitudinal/transverse crossbar switch, the second logic blocks being electrically connected to the longitudinal/transverse crossbar switch, the longitudinal/transverse crossbar switch being in a circuit switching mode; and
a global control block, one side of the global control block being electrically connected to and serving to receive/transmit control signals to the memory control blocks, the first logic blocks, the longitudinal/transverse crossbar switch, the bus direct memory access block and the second logic blocks, the other side of the global control block and the bus direct memory access block and the second logic blocks form a system bus.

2. The system on chip as claimed in claim 1, wherein the multiple memory blocks, the multiple memory control blocks and the multiple first logic blocks form a north section, while the bus direct memory access block and the second logic blocks form a south section.

3. The system on chip as claimed in claim 1, wherein the first logic blocks and the second logic blocks respectively serve to perform calculation of different bandwidths.

4. The system on chip as claimed in claim 1, wherein the total bandwidth of the first logic blocks is larger than or equal to the total bandwidth of the memory blocks and the total bandwidth of the longitudinal/transverse crossbar switch is smaller than or equal to the total bandwidth of the first logic blocks.

5. A system on chip comprising:
multiple memory blocks;
multiple memory control blocks;
multiple first logic blocks;
a longitudinal/transverse crossbar switch;
a bus direct memory access block;
multiple second logic blocks, the memory blocks and the memory control blocks being electrically connected to each other, the memory control blocks and the first logic blocks being electrically connected to each other, the first logic blocks being electrically connected to the longitudinal/transverse crossbar switch, the bus direct memory access block being electrically connected to the longitudinal/transverse crossbar switch, the second logic blocks being electrically connected to the longitudinal/transverse crossbar switch, the longitudinal/transverse crossbar switch being in a circuit switching mode; and
a global control block, one side of the global control block being electrically connected with and serving to receive/transmit control signals to the memory control blocks, the first logic blocks, the longitudinal/transverse crossbar switch, the bus direct memory access block and the second logic blocks, the other side of the global control block and the bus direct memory access block and the second logic blocks form a system bus, the multiple memory blocks, the multiple memory control blocks and the multiple first logic blocks forming a north section, the bus direct memory access block and the second logic blocks forming a south section, multiple optical transceivers being placed in the longitudinal/transverse crossbar switch, optical strapping being formed between the optical transceivers.

6. The system on chip as claimed in claim 5, wherein the first logic blocks and the second logic blocks respectively serve to perform calculation of different bandwidths.

7. The system on chip as claimed in claim 5, wherein the total bandwidth of the first logic blocks is larger than or equal to the total bandwidth of the memory blocks and the total bandwidth of the longitudinal/transverse crossbar switch is smaller than or equal to the total bandwidth of the first logic blocks.

8. The system on chip as claimed in claim 5, wherein the longitudinal/transverse crossbar switch is two interconnect layers, which are respectively longitudinally arranged and transversely arranged.

9. The system on chip as claimed in claim 8, wherein the longitudinally arranged interconnect layers and the transversely arranged interconnect layers are respectively used to connect to the north section and the south section.

10. The system on chip as claimed in claim 5, wherein the longitudinal/transverse crossbar switch is three interconnect layers, one of the three interconnect layers being longitudinally arranged or transversely arranged, while the other two of the three interconnect layers being longitudinally arranged or transversely arranged.

11. The system on chip as claimed in claim 10, wherein one of the three interconnect layers is used to connect with the optical transceivers, another one of the three interconnect layers is used to connect to the north section and the south section, while the final one of the three interconnect layers is commonly used to connect with the optical transceivers and the north section and the south section.

12. The system on chip as claimed in claim 5, wherein the longitudinal/transverse crossbar switch has a fourth interconnect layer, two of the four interconnect layers being longitudinally arranged, while the other two of the fourth interconnect layers being transversely arranged.

13. The system on chip as claimed in claim 12, wherein the two longitudinally arranged interconnect layers are used to connected to the north section, while the two transversely arranged interconnect layers are used to connect to the south section, one of the longitudinally arranged interconnect layers and one of the transversely arranged interconnect layers being respectively used to connect to the optical transceivers.
